(19) United States
(12) Patent Application Publication
(10) Pub. No.: US 2026/0321721 A1
(43) Pub. Date: Oct. 15, 2026

(54) ALIOVALENTLY SUBSTITUTED ARGYRODITE-TYPE SOLID ELECTROLYTES

(71) Applicant: Umicore, Brussels (BE)

(72) Inventors: Enora LAVANANT, Grenoble (FR); Alexander HOFMANN, Hanau (DE); Vishank KUMAR, Olen (BE); Florencia MARCHINI, Olen (BE)

(21) Appl. No.: 19/485,775

(22) PCT Filed: May 23, 2024
(86) PCT No.: PCT/EP2024/064281

§ 371 Date: Nov. 19, 2025

(30) Foreign Application Priority Data
May 24, 2023 (EP) 23290018.3

(51) Int. Cl. H01M 10/0562; H01M 10/052

(52) U.S. Cl. CPC H01M 10/0562; H01M 10/052; H01M 2300/0068

(57) ABSTRACT

The present invention relates to aliovalently substituted argyrodite-type solid electrolyte solid electrolytes. These solid electrolytes display and increased ionic conductivity.

### TECHNICAL FIELD AND BACKGROUND

This invention relates to an aliovalently substituted argyrodite-type solid electrolyte, a method for manufacturing said solid electrolyte and a battery comprising said solid electrolyte.

As the development of small and lightweight electronic products, electronic devices, communication devices and the like has advanced rapidly and a need for electric vehicles has widely emerged with respect to environmental issues, there is a demand for improvement of performance of secondary batteries used as power sources for these products. Among these, a lithium secondary battery has come into the spotlight as a high-performance battery due to a high energy density and a high reference electrode potential.

However, electrolytes conventionally used in lithium secondary batteries are liquid electrolytes such as organic solvents. Accordingly, safety problems such as leakage of electrolytes and risk of fire may continuously occur. Recently, solid state batteries including solid electrolytes, rather than liquid electrolytes, are being developed to improve the safety feature of the lithium secondary battery and have attracted much attention. For example, solid electrolytes are typically safer than liquid electrolytes due to non-combustible or flame retardant properties.

Solid electrolytes may include oxide-based solid electrolytes, polymer-based electrolytes and sulfide-based electrolytes. Sulfide-based electrolytes have been generally used due to their higher lithium ionic conductivity range compared to oxide based and polymer-based solid electrolytes, such as sulfide-based solid electrolytes having an argyrodite-type crystal structure.

Minafra et al (J. Mater. Chem. A 2018, 6, 645-651) describes the synthesis of solid electrolytes having the general formula Li₆₊ₓP₁₋ₓSiₓS₅Br with 0≤x≤0.5, such as Li_{6.125}P_{0.875}Si_{0.125}S₅Br and Li_{6.35}P_{0.65}Si_{0.35}S₅Br.

Strauss et al (Inorg. Chem. 2020, 59, 12954-12959) describes the synthesis of Li₇GeS₅Br having an argyrodite structure.

It is an object of the present invention to provide an aliovalently substituted argyrodite-type solid electrolyte.

It is a further object of the present invention to provide a method for manufacturing said solid electrolyte.

It is a further object of the present invention to provide a battery comprising said solid electrolyte.

### SUMMARY OF THE INVENTION

In a first aspect an object of the present invention is achieved by providing a solid electrolyte having a composition according to formula (I)

$${Li}_{7 - a} {YS}_{5 - a} {X}_{1 + a} \qquad ( I )$$

wherein-1.0≤a≤1.0,
Y is selected from the group consisting of Si, Ge, and Ti, and
X is selected from group consisting of F, Cl, Br, I and any combination thereof.

A highly preferred embodiment is the solid electrolyte of the invention with the proviso that when Y=Ge and a=0, X≠Br.

In certain preferred embodiments the solid electrolyte is according to the invention, having a composition according to formula (II)

$${Li}_{7 - b} {YS}_{5 - b} {ZQ}_{b} \qquad ( II )$$

wherein 0<b≤1.0,
Y is selected from the group consisting of Si, Ge and Ti,
Z is selected from group consisting of F, Cl, Br and I,
Q is selected from group consisting of F, Cl, Br and I, and
Z and Q are not the same halogen.

The present inventors have surprisingly found that aliovalently substituted argyrodite-type solid electrolyte compositions display an increased ionic conductivity up to 2 mS·cm⁻¹, as demonstrated in the appended examples.

Without wishing to be bound to any theory the present inventors believe that aliovalent substitution of P with Si, Ge or Ti leads to an expansion of the unit cell, as well as the inclusion of additional lithium cations within the structure. Additionally halide substitutions result in an increase of X⁻/S²⁻ site disorder. Hence, by changing the structure, the lithium content increases, as well as the ion interactions, leading to an increase in the ionic conductivity, as demonstrated in the appended examples. Moreover, these observations were supported by computational modelling, which focuses on predicting the rate of lithium diffusion into the argyrodite structure based on two indicators, Eₕᵤₗₗ (energy above hull) and E_{mig} (migration energy barrier). The Eₕᵤₗₗ identifies the stability of certain argyrodite compounds, while E_{mig} is an ionic conductivity predictor.

In a further aspect the invention provides a method for manufacturing said solid electrolyte.

In a further aspect the invention provides the battery comprising the solid electrolyte according to the invention.

### BRIEF DESCRIPTION OF THE FIGURES

FIG. 1: X-ray diffraction patterns of Li₇SiS₅I, Li₇SiS₅Br and Li₇SiS₅Cl, recorded at 298 K in an airtight specimen holder with dome type from Bruker.

FIG. 2: X-ray diffraction patterns of Li_{7.5}SiS_{4.510.5} and Li₇SiS₅I, recorded at 298 K in an airtight specimen holder with dome type from Bruker.

FIG. 3: X-ray diffraction patterns of Li_{6.5}SiS_{4.5}Br_{0.5}I and Li_{6.5}SiS_{4.5}BrI_{0.5}, recorded at 298 K in an airtight specimen holder with dome type from Bruker.

### DETAILED DESCRIPTION

In the drawings and the following detailed description, preferred embodiments are described in detail to enable practice of the invention. Although the invention is described with reference to these specific preferred embodiments, it will be understood that the invention is not limited to these preferred embodiments. To the contrary, the invention includes numerous alternatives, modifications and equivalents as will become apparent from consideration of the following detailed description and accompanying drawings.

The term “comprising”, as used herein and in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a composition comprising components A and B” should not be limited to compositions consisting only of components A and B. It means that with respect to the present invention, the only relevant components of the composition are A and B. Accordingly, the terms “comprising” and “including” encompass the more restrictive terms “consisting essentially of” and “consisting of”.

The term “solid-state battery” as used herein refers to a cell or a battery that includes only solid or substantially solid-state components such as solid electrodes (e.g. anode and cathode) and a solid electrolyte.

The term “argyrodite-type crystal structure” as used herein refers to a crystal structure having a crystal structure or system similar to naturally existing Ag₈GeS₆ and Li₇PS₆ (Argyrodite). The argyrodite-type crystal structure may be of orthorhombic symmetry and described in the F-43m space group. In some embodiments the argyrodite-type crystal structure may also be empirically determined, for example by X-ray diffraction by observing diffraction peaks around at 2θ±15.5±1°, 18±1°, 26±1°, 30.5±1° and 32±1° using CuKα-ray wavelength. X-Ray diffraction (XRD) as referred to herein, refers to XRD experiments performed using Bruker D8 diffractometers equipped with either Cu(Kα₁-Kα₂) radiation in a θ-θ configuration. Preferably, an air-tight sample holder dome window from Bruker (transparent to X-rays) is used. Preferably, the patterns were collected between 20=10°-50° with a step size of 0.02°.

Ionic conductivity as referred to herein, refers to the ionic conductivity determined at 23° C., unless described otherwise. It is preferably determined on cold pressed samples in a 13 mm die at 375 MPa with a BioLogic CESH cell and spectra were recorded using MTZ 35 frequency response analyzer by applying 50 mV AC perturbation in the frequency range from 7 MHz to 1 Hz. Preferably, the relative density of the pellet was 90 to 92% and the thickness was 2.5 mm approximately. Preferably, nickel foils were pressed on the surface of pellets as ion-blocking electrodes. More preferably, spectra were collected between the temperature of range of 23° C. with 10° C. intervals.

The term “solid electrolyte” as used herein refers to an electrolyte being essentially free of any liquid. The term “essentially free of liquid” means that the solid electrolyte comprises less than 10 wt. % of a liquid by total weight of the solid electrolyte, preferably less than 7.5 wt. %, more preferably less than 5 wt. %, even more preferably less than 2.5 wt. %, most preferably less than 1 wt. % by total weight of the solid electrolyte. In a more preferred embodiment the solid electrolyte comprises less than 1000 ppm of a liquid by total weight of the solid electrolyte, preferably less than 500 ppm, more preferably less than 100 ppm, even more preferably less than 50 ppm, most preferably less than 10 ppm by total weight of the solid electrolyte.

### Solid Electrolyte

In a first aspect an object of the present invention is achieved by providing a solid electrolyte having a composition according to formula (I)

$${Li}_{7 - a} {YS}_{5 - a} {X}_{1 + a} \qquad ( I )$$

wherein-1.0≤a≤1.0,
Y is selected from the group consisting of Si, Ge and Ti, and
X is selected from group consisting of F, Cl, Br, I and any combination thereof.

A highly preferred embodiment is the solid electrolyte according to the invention with the proviso that when Y=Ge and a=0, X+Br.

In certain highly preferred embodiments the solid electrolyte of the invention with the proviso that solid electrolyte is not according to formula (I)′

$${Li}_{7} {GeS}_{5} X \qquad {( I )}^{′}$$

wherein X is selected from group consisting of F, Cl, Br, I and any combination thereof.

In preferred embodiments the solid electrolyte is according to the invention, wherein −0.99≤a≤0.99, preferably −0.95≤a≤0.95, more preferably −0.75≤a≤0.75, most preferably −0.5≤a≤0.5.

In preferred embodiments the solid electrolyte is according to the invention, wherein a=−0.5, 0 or 0.5, more preferably a=0.5.

In certain preferred embodiments the solid electrolyte is according to the invention, wherein Y is Si, Ge or Ti; preferably Y is Si or Ge, or preferably Y is Si or Ti; more preferably Y is Si.

In certain preferred embodiments the solid electrolyte is according to the invention, wherein X is Cl, Br, I or a combination thereof; preferably X is Br, I or a combination thereof; more preferably X is Br or I.

In certain preferred embodiments the solid electrolyte is according to the invention, wherein X is F, Cl, Br or I; preferably X is Cl, Br or I; more preferably X is Br or I; most preferably X is I.

In accordance with preferred embodiments of the invention, the solid electrolyte is provided, wherein at least 50 mol % of X represents F, preferably at least 80 mol % of X represents F, most preferably X represents F.

In accordance with preferred embodiments of the invention, the solid electrolyte is provided, wherein X represents F, Cl, Br, I or a combination thereof and wherein at least 50 mol % of X represents F, preferably at least 80 mol % of X represents F.

In accordance with preferred embodiments of the invention, the solid electrolyte is provided, wherein at least 50 mol % of X represents Cl, preferably at least 80 mol % of X represents Cl, most preferably X represents Cl.

In accordance with preferred embodiments of the invention, the solid electrolyte is provided, wherein X represents F, Cl, Br, I or a combination thereof and wherein at least 50 mol % of X represents Cl, preferably at least 80 mol % of X represents Cl.

In accordance with preferred embodiments of the invention, the solid electrolyte is provided, wherein at least 50 mol % of X represents Br, preferably at least 80 mol % of X represents Br, most preferably X represents Br.

In accordance with preferred embodiments of the invention, the solid electrolyte is provided, wherein X represents F, Cl, Br, I or a combination thereof and wherein at least 50 mol % of X represents Br, preferably at least 80 mol % of X represents Br.

In accordance with preferred embodiments of the invention, the solid electrolyte is provided, wherein at least 50 mol % of X represents I, preferably at least 80 mol % of X represents I, most preferably X represents I.

In accordance with preferred embodiments of the invention, the solid electrolyte is provided, wherein X represents F, Cl, Br, I or a combination thereof and wherein at least 50 mol % of X represents I, preferably at least 80 mol % of X represents I.

In certain preferred embodiments the solid electrolyte is according to the invention, wherein
Y is Si,
X is Cl, and
−0.5≤a≤0.5, preferably −0.5≤a≤0, more preferably a=0 or 0.5.

In certain preferred embodiments the solid electrolyte is according to the invention, wherein
Y is Si,
X is Br, and
−0.5≤a≤0.5, preferably a=−0.5, 0 or 0.5, more preferably a=−0.5 or 0.5.

In certain preferred embodiments the solid electrolyte is according to the invention, wherein
Y is Si,
X is I, and
−0.5≤a≤0.5, preferably a=−0.5, 0 or 0.5, more preferably a=0.5.

In more preferred embodiments the solid electrolyte is according to the invention, wherein the solid electrolyte is according to the formula (I) a-i:

| | |
|---|---|
| Li_{7.5}SiS_{5.5}Cl_{0.5} | (I)a |
| Li₇SiS₅Cl | (I)b |
| Li₇SiS₅Cl_{1.5} | (I)c |
| Li_{7.5}SiS_{5.5}Br_{0.5} | (I)d |
| Li₇SiS₅Br | (I)e |
| Li_{6.5}SiS_{4.5}Br_{1.5} | (I)f |
| Li_{7.5}SiS_{5.5}I_{0.5} | (I)g |
| Li₇SiS₅I | (I)h |
| Li_{6.5}SiS_{4.5}I_{1.5} | (I)i |

In preferred embodiments the solid electrolyte is a powder.

In preferred embodiments the solid electrolyte is according to the invention having an argyrodite-type crystal structure.

In preferred embodiments the solid electrolyte is according to the invention, wherein the molar ratios of Li: Y: S: X are between (5-8):(0.9-1.1):(4-6):(0.1-1.9), preferably (6.5-7.5):(0.99-1.01):(4.5-5.5):(0.5-1.5), more preferably (6.5):(1.0):(4.5):(1.5) or (7.0):(1.0):(5.0):(1.0) or (7.5):(1.0):(4.5):(0.5).

In preferred embodiments the solid electrolyte is according to the invention having a purity of at least 90%, preferably at least 95%, more preferably at least 99%, as determined by XRD.

In preferred embodiments the solid electrolyte is according to the invention having a conductivity between 0.1 and 5 mS/cm, preferably between 0.5 and 3.5 mS/cm, more preferably between 1 and 2.5 mS/cm.

In certain preferred embodiments the solid electrolyte of the invention is according to formula (I) a, preferably having a conductivity between 0.5 and 1.5 mS/cm, more preferably between 0.75 and 1.25 mS/cm, most preferably about 1.1 mS/cm.

In certain preferred embodiments the solid electrolyte of the invention is according to formula (I) b, preferably having a conductivity between 0.5 and 1.5 mS/cm, more preferably between 0.75 and 1.25 mS/cm, most preferably about 1.0 mS/cm.

In certain preferred embodiments the solid electrolyte of the invention is according to formula (I) d, preferably having a conductivity between 1.0 and 2.0 mS/cm, more preferably between 1.25 and 1.75 mS/cm, most preferably about 1.5 mS/cm.

In certain preferred embodiments the solid electrolyte of the invention is according to formula (I) e, preferably having a conductivity between 1.0 and 2.0 mS/cm, more preferably between 1.25 and 1.75 mS/cm, most preferably about 1.3 mS/cm.

In certain preferred embodiments the solid electrolyte of the invention is according to formula (I) f, preferably having a conductivity between 1.0 and 2.0 mS/cm, more preferably between 1.25 and 1.75 mS/cm, most preferably about 1.5 mS/cm.

In certain preferred embodiments the solid electrolyte of the invention is according to formula (I) g, preferably having a conductivity between 1.0 and 2.5 mS/cm, more preferably between 1.50 and 2.0 mS/cm, most preferably about 1.7 mS/cm.

In certain preferred embodiments the solid electrolyte of the invention is according to formula (I) h, preferably having a conductivity between 1.0 and 2.5 mS/cm, more preferably between 1.50 and 2.0 mS/cm, most preferably about 1.7 mS/cm.

In certain preferred embodiments the solid electrolyte of the invention is according to formula (I) i, preferably having a conductivity between 1.0 and 2.5 mS/cm, more preferably between 1.50 and 2.0 mS/cm, most preferably about 1.8 mS/cm.

In certain preferred embodiments the solid electrolyte is according to the invention, having a composition according to formula (II)

$${Li}_{7 - b} {YS}_{5 - b} {ZQ}_{b} \qquad ( II )$$

wherein 0<b≤1.0,
Y is selected from the group consisting of Si, Ge and Ti,
Z is selected from group consisting of F, Cl, Br and I,
Q is selected from group consisting of F, Cl, Br and I, and
Z and Q are not the same halogen.

In preferred embodiments the solid electrolyte is according to formula (II), wherein 0.01≤b≤0.99, preferably 0.25≤b≤0.75, more preferably 0.4≤b≤0.6, most preferably b is about 0.5.

In preferred embodiments the solid electrolyte is according to formula (II), wherein Y is Si, Ge or Ti, preferably Y is Si or Ge or preferably Y is Si or Ti, more preferably Y is Si.

In preferred embodiments the solid electrolyte is according to formula (II), wherein Z is Cl, Br or I, preferably Br or I.

In preferred embodiments the solid electrolyte is according to formula (II), wherein Q is Cl, Br or I, preferably Br or I.

In certain preferred embodiments the solid electrolyte is according to formula (II), wherein
Y is Si;
Z is Br;
Q is I; and
0.25≤b≤0.75, more preferably 0.4≤b≤0.6, most preferably b is about 0.5.

In certain preferred embodiments the solid electrolyte is according to formula (II), wherein
Y is Si;
Z is I;
Q is Br; and
0.25≤b≤0.75, more preferably 0.4≤b≤0.6, most preferably b is about 0.5.

In more preferred embodiments the solid electrolyte is according to the invention, wherein the solid electrolyte is according to formula (II) a-b:

| | |
|---|---|
| Li_{6.5}SiS_{4.5}BrI_{0.5} | (II)a |
| Li_{6.5}SiS_{4.5}Br_{0.5}I | (II)b |

In preferred embodiments the solid electrolyte is according to formula (II) having an argyrodite-type crystal structure.

In preferred embodiments the solid electrolyte is according to formula (II), wherein the molar ratios of Li: Y: S: Z: Q are between (5-8):(0.9-1.1):(4-6):(0.1-1.5):(0.1-1.5), preferably (6.5-7.5):(0.99-1.01):(4.5-5.5):(0.5-1.0):(0.5-1.0), more preferably (6.5):(1.0):(4.5):(0.5):(1.0) or (6.5):(1.0):(4.5):(1.0):(0.5) or (7.0):(1.0):(5.0):(0.5):(0.5).

In preferred embodiments the solid electrolyte is according to formula (II) having a purity of at least 90%, preferably at least 95%, more preferably at least 99%, as determined by XRD.

In preferred embodiments the solid electrolyte is according to formula (II) having a conductivity between 0.1 and 5 mS/cm, preferably between 0.5 and 3.5 mS/cm, more preferably between 1 and 2.5 mS/cm.

In certain preferred embodiments the solid electrolyte of the invention is according to formula (II) a, preferably having a conductivity between 1.5 and 2.5 mS/cm, more preferably between 2.0 and 2.5 mS/cm, most preferably about 2.4 mS/cm.

In certain preferred embodiments the solid electrolyte of the invention is according to formula (II) b, preferably having a conductivity between 1.5 and 2.5 mS/cm, more preferably between 2.0 and 2.5 mS/cm, most preferably about 2.1 mS/cm.

### Method for Manufacturing

In a second aspect the invention provides a method for manufacturing a solid electrolyte comprising the following steps:
a) providing a set of precursors comprising Li, S, Y and X; and
b) mixing of the set of precursors to obtain a solid electrolyte mixture; and
c) heat-treating of the solid electrolyte mixture to obtain a solid electrolyte;
wherein Y is selected from the group consisting of Si, Ge and Ti;
wherein X is selected from the group consisting of F, Cl, Br and I, preferably Cl, Br or I, more preferably Br or I, most preferably I.

In a preferred embodiment of the method X consists of Z and Q,
wherein Z is selected from the group consisting of F, Cl, Br and I, preferably Cl, Br or I, more preferably Br or I,
wherein Q is selected from the group consisting of F, Cl, Br and I, preferably Cl, Br or I, more preferably Br or I, and
wherein Z and Q are not the same halogen.

In highly preferred embodiments the method is according to the invention, wherein the set of precursors comprises Li₂S, one or more of the group consisting of Si₂S, Ge₂S and Ti₂S, preferably Si₂S, and one or more of the group consisting of LiI, LiBr and LiCl.

In highly preferred embodiments the method is according to the invention, wherein the solid electrolyte is the solid electrolyte according to the first aspect of the invention, preferably the solid electrolyte according to formula (I) and/or according to formula (II), preferably according to formula (I) a-i and/or formula (II) a-b.

As appreciated by the skilled person all embodiments related to the solid electrolyte according to first aspect of the invention apply mutatis mutandis to the method for manufacturing the solid electrolyte according to the invention. For example, the various embodiments relating to formula (I), formula (II), purity level and conductivity level as explained herein in the context of the solid electrolyte are equally applicable to the method for manufacturing the solid electrolyte according to the invention.

In preferred embodiments the method is according to the invention, wherein the mixing of the solid electrolyte precursor of step b) may comprise mixing, grinding, stirring, ball-milling, or a combination thereof.

In preferred embodiments the method is according to the invention, wherein the mixing of the set of precursors of step b) with a mixing speed of at least 100 rpm, preferably a mixing speed of at least 300 rpm, most preferably a mixing speed of at least 400 rpm. In preferred embodiments the method is according to the invention, wherein the mixing of the set of precursors of step b) with a mixing speed of at most 1000 rpm, preferably a mixing speed of at most 900 rpm, most preferably a mixing speed of at most 800 rpm. In preferred embodiments the method is according to the invention, wherein the mixing of the set of precursors of step b) with a mixing speed of 100-1000 rpm, preferably a mixing speed of 300-900 rpm, most preferably a mixing speed of 400-800 rpm.

A certain preferred embodiment is the method according to the invention, wherein the mixing of the set of precursors of step b) is carried out by using a mixing means such as a ball mill such as an electric ball mill, a vibration ball mill, a planetary ball mill, a vibration mixer mill or a SPEX mill; a bead mill; a homogenizer; a screw mixer; a horizontal mixer; a ploughshare mixer; a jar mill; a drum mill or a roller bench. In a more preferred embodiment the mixing of the set of precursors of step b) is carried out by adding one or more ceramic or zirconia balls to the set of precursors. As appreciated by the skilled person the amount and size of the ceramic or zirconia balls is changed in view of the total solid amount of the set of precursors.

As appreciated by the skilled person these ceramic or zirconia balls are removed before the heat-treating step c).

In preferred embodiments the method is according to the invention, wherein the mixing of the set of precursors of step b) is at least 1 hour, preferably at least 5 hours, most preferably at least 10 hours. In preferred embodiments the method is according to the invention, wherein the mixing of the set of precursors of step b) is at most 70 hours, preferably at most 50 hours, most preferably at most 30 hours. In preferred embodiments the method is according to the invention, wherein the mixing of the set of precursors of step b) is between 1 hour to 70 hours, preferably between hours to 50 hours, most preferably between 10 hours to 30 hours.

In preferred embodiments the method is according the invention, wherein the mixing of the solid electrolyte precursor mixture of step b) occurs at a temperature of at least 5° C., preferably at least 10° C., more preferably at least 15° C. A preferred embodiment is the method according to the invention, wherein the mixing of the solid electrolyte precursor mixture of step b) occurs at a temperature of less than 50° C., preferably less than 40° C., more preferably less than 30° C. A preferred embodiment is the method according to the invention, wherein the mixing of the solid electrolyte precursor mixture of step b) occurs at a temperature between 5 and 50° C., preferably a temperature between 1° and 40° C., more preferably a temperature between 15 and 30° C.

In certain preferred embodiments the method is according to the invention, wherein the mixing of the solid electrolyte precursor of step b)
with a mixing time between 1 hour and 70 hours, preferably between 5 hours and 50 hours, most preferably between 10 hours and 30 hours; and
with a mixing speed of 100-1000 rpm, preferably a mixing speed of 300-900 rpm, most preferably a mixing speed of 400-800 rpm.

In preferred embodiments the method is according to the invention, wherein the heat-treating of the solid electrolyte mixture of step c) occurs at a temperature of at least 100° C., preferably at least 150° C., more preferably at least 200° C., even more preferably at least 250° C., most preferably at least 300° C. In preferred embodiments the method is according to the invention, wherein the heat-treating of the solid electrolyte mixture of step c) occurs at a temperature of less than 1000° C., preferably less than 900° C., more preferably less than 750° C., even more preferably less than 600° C., most preferably less than 500° C. In preferred embodiments the method is according to the invention, wherein the heat-treating of the solid electrolyte mixture of step c) occurs at a temperature between 10° and 1000° C., preferably between 20° and 750° C., most preferably between 25° and 450° C.

In preferred embodiment the method is according to the invention, wherein the heat-treating of the solid electrolyte mixture of step c) is at least 1 min, preferably at least 0.5 hour, more preferably at least 1 hour, even more preferably at least 1.5 hours, most preferably at least 2 hours. In preferred embodiments the method is according to the invention, wherein the heat-treating of the solid electrolyte mixture of step c) is less than 24 hours, preferably less than 12 hours, more preferably less than 10 hours, even more preferably less than 8 hours, even more preferably less than 6 hours. In preferred embodiments the method is according to the invention, wherein the heat-treating of the solid electrolyte mixture of step c) is between 0.5 hour and 24 hours, preferably between 1 hours and 12 hours, more preferably between 2 hours and 6 hours.

In certain preferred embodiment the method is according to the invention, wherein the heat-treating of the solid electrolyte mixture of step c)
occurs at a temperature between 10° and 1000° C., preferably between 20° and 750° C., most preferably between 25° and 450° C.; and
is between 0.5 hour and 24 hours, preferably between 1 hours and 12 hours, most preferably between 2 hours and 6 hours.

### Product-by-Process

In a third aspect the invention concerns the solid electrolyte obtainable by the method according to the second aspect of the invention.

As appreciated by the skilled person all embodiments directed to the solid electrolyte according to the first aspect of the invention and/or the method according to the second aspect of the invention apply mutatis mutandis to solid electrolyte obtainable by the method according to the invention. For example, the various embodiments relating to formula (I), formula (II), purity level and conductivity level as explained herein in the context of the solid electrolyte are equally applicable to the solid electrolyte obtainable by the method for manufacturing the solid electrolyte.

### Battery

A fourth aspect of the invention concerns a battery comprising a negative electrode, a positive electrode and a solid electrolyte layer, wherein at least one of the positive electrode, the negative electrode and the solid electrolyte layer comprises the solid electrolyte according to the invention. The present solid electrolyte of the invention can be used as a solid electrolyte layer of a solid lithium ion battery or a solid lithium primary cell, or as a solid electrolyte that is mixed with an electrode mixture for a positive electrode or a negative electrode.

In a preferred embodiment the battery is a solid-state battery, preferably a lithium solid-state battery.

### Use

A fifth aspect of the invention concerns a use of the solid electrolyte according to the invention in a battery, preferably a solid-state-battery, most preferably a lithium solid-state-battery.

A sixth aspect of the present invention concerns a use of the battery according to the invention in either one of a portable computer, a tablet, a mobile phone, an energy storage system, an electric vehicle or in a hybrid electric vehicle, preferably in a vehicle or in a hybrid electric vehicle.

The invention is further illustrated in the following examples.

### Examples

### Description of Testing Methods

### Computational Protocol

The computational model focuses on predicting the thermodynamic stability and the rate of lithium diffusion into the argyrodite structure based on Eₕᵤₗₗ (energy above hull) and E_{mig} (migration energy barrier), respectively.

The Eₕᵤₗₗ is a key indicator to identify the relative stability of a phase as compared to the other phases present in the multi-component phase diagram of the combining elements. For instance, to identify the phase stability of an argyrodite compound, one would need to calculate the energies of all known phases in the Li—P—S—CI chemical space to construct the phase diagram. The method of constructing a convex hull of a multi-component phase diagram at 0 K is a standard computational method. The energy of each phase is then calculated with respect to the energy of the convex hull taken as 0 and referred as “Eₕᵤₗₗ”. Thus, the higher the value of Eₕᵤₗₗ, higher it lies above the convex hull of most stable phases and lower is it's thermodynamic stability. This parameter is used to rank most stable compounds and indicate the most likely to be synthesizable.

During charging and discharging the lithium ions jump from one stable site to another by overcoming an energy barrier to traverse the potential energy landscape. The height of these energy barriers are estimated by the bond valence method that relates the length of the bond (R_{A—X} calculated from geometry) to its strength (S_{A-X}) where A and X are lithium ion and its neighboring atoms, respectively. The relation is given by the following formula:

$${s}_{A - X} = exp [ ( {R}_{0} - {R}_{A - X / b} ) ]$$

where R₀ and b are empirical bond valence (BO) parameters. This relationship allows one to locate the accessible positions for mobile lithium ions in the local structure of electrolyte as positions where the sum of these bond valence V(A)=Σxs_{A-X} is closest to V_{ideal}, the ideal valence (oxidation state) of a lithium ion. The lowest energy pathway is the one where the valence sum deviation |V_{(A)}−V_{ideal(A)}| is minimum and the corresponding energy barrier is the minimum migration energy barrier for lithium ions to diffuse in the electrolyte. The lower the migration energy barrier (E_{mig}), the higher the lithium ion diffusivity and thus resulting in a higher ionic conductivity of the electrolyte. Thus, E_{mig} is an ionic conductivity indicator to rank promising candidates. The migration energies have been evaluated with the code BOND_STR, distributed within the FullProf package of the CrysFML library.

### Synthesis Protocol

All the synthesis work and sample treatment were carried out in Ar filled glovebox with O₂ and H₂O levels <0.1 ppm. Stoichiometric ratios of reagents, Li₇S (Albemarle, 99.9%), SiS₂ (LTS US, 99%), LiCl (Sigma Aldrich, 99,98%), and/or LiBr (Sigma Aldrich, 99%), and/or LiI (Sigma Aldrich, 99.9%) were weighed to obtain a 15 g batch of precursor. The precursors were transferred into a Restch PM 100 using 250 mL zirconia ball-milling jar along with 16 zirconia balls of 20 mm diameter (Ball: powder ratio was 30:1). The precursors were initially milled at 100 rpm for 60 minutes to homogenize the mixture followed by ball milling at 510 rpm for a total duration of 25 hours. Each cycle constituted in 5-minute milling and 5-minute rest and reversing the direction of milling for every cycle. At the end of the ball milling step, approximately 96 wt % of the material was recovered. The ball-milled powder was placed in dried quartz tubes which were then closed under Ar and placed in a furnace (Nabertherm) for heat treatment. The temperature of the furnace was slowly increased to 300° C. at a ramp rate of 2° C./min, held for 2 hours, and naturally cooled to room temperature. The reacted powders were then pulverized using a pestle and mortar and stored in the glovebox for further analysis.

### X-Ray Diffraction

The powder X-ray diffraction patterns were collected using Bruker D8 diffractometers equipped with either Cu(Kα₁-Kα₂) radiation in a θ-θ configuration. An air-tight sample holder with dome type was used for the measurements. The patterns were collected between 20=10°-50° with a step size of 0.02°.

### Ionic Conductivity Measurements

About 500 mg of sample was uniaxially cold-pressed in a 13 mm die at 375 MPa. The relative density of the pellet was 90 to 92% and the thickness was 2.5 mm approximately. AC impedance spectroscopy was performed on these pellets by mounting them into a pellet in a pouch cell and spectra were recorded using Biologic analyzer by applying 50 mV AC perturbation in the frequency range from 7 MHz to 1 Hz. Spectra were collected at 23° C. The AC impedance data were analyzed using Zview or RelaxIS software.

### Examples

Table 1 displays the Eₕᵤₗₗ and E_{mig} for a series of solid electrolyte matching formula (I).

TABLE 1
Eₕᵤₗₗ and E_{mig} for CEX1-3 and EX1-8 and EX11-20.

Computational
Predictions

| Examples | Formula | Eₕᵤₗₗ (eV) | E_{mig} (eV) |
|---|---|---|---|
| CEX1 | Li₆PS₅l | 0.03 | 0.82 |
| CEX2 | Li₆PS₅Cl | 0.09 | 0.55 |
| CEX3 | Li₆PS₅Br | 0.06 | 0.60 |
| EX1 | Li_{7.5}SiS_{5.5}Cl_{0.5} | 0.00 | 0.63 |
| EX2 | Li₇SiS₅Cl | 0.00 | 0.61 |
| EX3 | Li_{7.5}SiS_{5.5}Br_{0.5} | 0.00 | 0.62 |
| EX4 | Li₇SiS₅Br | 0.00 | 0.69 |
| EX5 | Li_{6.5}SiS_{4.5}Br_{1.5} | 0.00 | 0.72 |
| EX6 | Li_{7.5}SiS_{5.5}I_{0.5} | 0.00 | 0.72 |
| EX7 | Li₇SiS₅I | 0.00 | 0.87 |
| EX8 | Li_{6.5}SiS_{4.5}I_{1.5} | 0.00 | 0.86 |
| EX11 | Li₈SiS₄ | 0.00 | 0.65 |
| EX12 | Li₈GeS₄ | 0.04 | 0.65 |
| EX13 | Li_{6.5}SiS_{4.5}Cl_{1.5} | 0.01 | 0.63 |
| EX14 | Li_{7.5}GeS_{5.5}Cl_{0.5} | 0.05 | 0.65 |
| EX15 | Li₇GeS₅Cl | 0.05 | 0.63 |
| EX16 | Li_{6.5}GeS_{4.5}Cl_{1.5} | 0.04 | 0.67 |
| EX17 | Li_{7.5}SiS_{5.5}Br_{0.5} | 0.04 | 0.66 |
| EX18 | Li₇SiS₅Br | 0.03 | 0.65 |
| EX19 | Li_{7.5}SiS_{5.5}I_{0.5} | 0.04 | 0.67 |
| EX20 | Li₇TiS₅I | 0.05 | 0.92 |

Table 2 displays the overall formula of the examples synthesized via the general synthesis protocol their corresponding measured ionic conductivity, Eₕᵤₗₗ and E_{mig}.

TABLE 2
Stochiometric formulas and ionic conductivity values for CEX1,
CEX4, EX1′-10′ and EX21′. The example EX1′-8′
and EX11′ are not according to the invention as claimed.
The examples EX9′ and EX10′ are according to the invention as claimed.

| | | Ionic conductivity at |
|---|---|---|
| Examples | Formula | 23 °C (mS · cm⁻¹) |
| CEX1 | Li₆PS₅l | 0.003 |
| CEX4 | Li_{5.6}PS_{4.6}l_{1.4} | 0.003 |
| EX1′ | Li_{7.5}SiS_{5.5}Cl_{0.5} | 1.1 |
| EX2′ | Li₇SiS₅Cl | 1.0 |
| EX3′ | Li_{7.5}SiS_{5.5}Br_{0.5} | 1.5 |
| EX4′ | Li₇SiS₅Br | 1.3 |
| EX5′ | Li_{6.5}SiS_{4.5}Br_{1.5} | 1.5 |
| EX6′ | Li_{7.5}SiS_{5.5}I_{0.5} | 1.7 |
| EX7′ | Li₇SiS₅I | 1.7 |
| EX8′ | Li_{6.5}SiS_{4.5}I_{1.5} | 1.8 |
| EX9′ | Li_{6.5}SiS_{4.5}BrI_{0.5} | 2.4 |
| EX10′ | Li_{6.5}SiS_{4.5}IBr_{0.5} | 2.1 |
| EX21′ | Li₇SiS₅Cl_{1.5} | n.a. |

n.a. = not available.

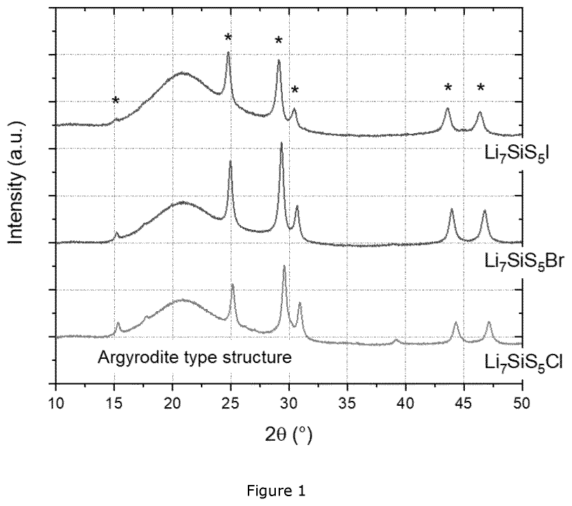

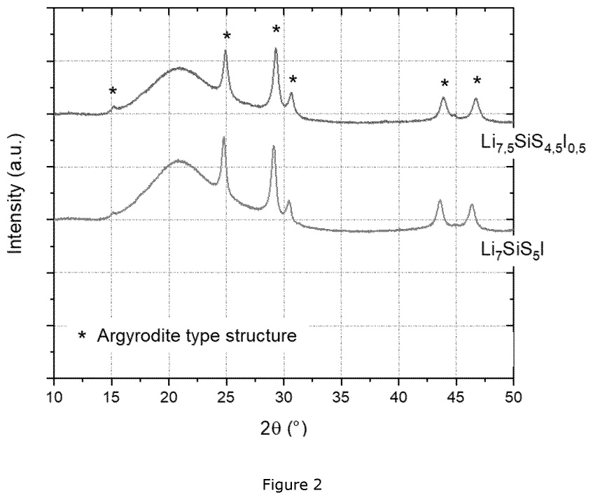

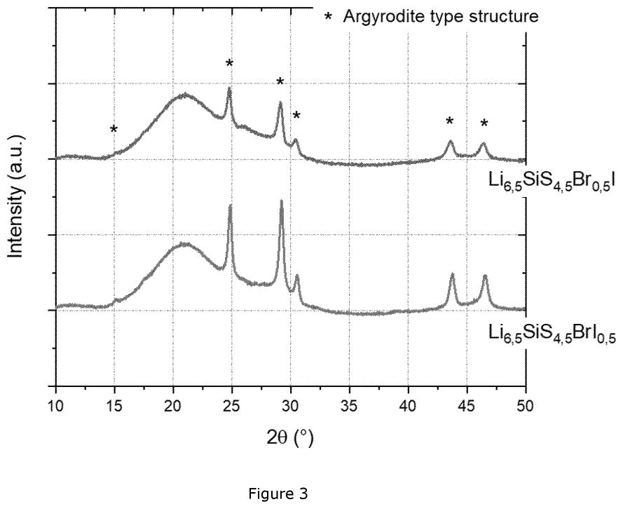

Profile matching of powder X-ray diffraction data suggest that the argyrodite structure is preserved for the samples EX2, 4, 7 (FIG. 1), EX6 and 7 (FIG. 2) and EX9 and 10 (FIG. 3) and no peaks corresponding to the precursors or other impurity phases are observed.

1-12. (canceled)

13. A solid electrolyte having a composition according to formula (I)
$${Li}_{7 - a} {YS}_{5 - a} {X}_{1 + a} , \qquad ( I )$$
wherein −1.0≤a≤1.0,
wherein Y is selected from the group consisting of Si, Ge and Ti, and
wherein X is selected from the group consisting of F, Cl, Br, I and any combination thereof, with the proviso that when Y=Ge and a=0, X≠Br,
and wherein the solid electrolyte has a composition according to formula (II)
$${Li}_{7 - b} {YS}_{5 - b} {ZQ}_{b} , \qquad ( II )$$
wherein 0<b≤1.0,
wherein Y is selected from the group consisting of Si, Ge and Ti,
wherein Z is selected from the group consisting of F, Cl, Br and I,
wherein Q is selected from the group consisting of F, Cl, Br and I, and
wherein Z and Q are not the same halogen.

14. The solid electrolyte according to claim 13, wherein −0.99≤a≤0.99.

15. The solid electrolyte according to claim 13, wherein Y is Si or Ge.

16. The solid electrolyte according to claim 13, wherein 0.01≤b≤0.99.

17. The solid electrolyte according to claim 13, wherein Y is Si or Ge.

18. The solid electrolyte according to claim 13, wherein Z is Cl, Br or I.

19. The solid electrolyte according to claim 13, wherein Q is Cl, Br or I.

20. The solid electrolyte according to claim 13, having a composition according to formula (II) a-b:

| | |
|---|---|
| Li_{6.5}SiS_{4.5}BrI_{0.5} | (II)a |
| Li_{6.5}SiS_{4.5}Br_{0.5}I | (II)b. |

21. The solid electrolyte according to claim 13, having an ionic conductivity between 0.1 and 5 mS/cm.

22. A method for manufacturing a solid electrolyte comprising the following steps:
a) providing a set of precursors comprising Li, S, Y and X;
b) mixing of the set of precursors to obtain a solid electrolyte mixture; and
c) heat-treating of the solid electrolyte mixture to obtain a solid electrolyte;
wherein Y is selected from the group consisting of Si, Ge and Ti,
wherein X is selected from the group consisting of F, Cl, Br and I and combinations thereof.

23. The method according to claim 22, wherein X consists of Z and Q,
wherein Z is selected from the group consisting of Cl, Br and I,
wherein Q is selected from the group consisting of Cl, Br and I, and
wherein Z and Q are not the same halogen.

24. A battery comprising a negative electrode, a positive electrode and a solid electrolyte layer, wherein at least one of the positive electrode, the negative electrode and the solid electrolyte layer comprises the solid electrolyte according to claim 13.
